(19) United States
(12) Patent Application Publication
(10) Pub. No.: US 2014/0059101 A1
(43) Pub. Date: Feb. 27, 2014

(54) OPTIMIZED METHOD OF BIQUAD INFINITE-IMPULSE RESPONSE CALCULATION

(71) Applicant: James C. Steele, Chandler, AZ (US)

(72) Inventor: James C. Steele, Chandler, AZ (US)

(73) Assignee: QUICKFILTER TECHNOLOGIES, LLC, Allen, TX (US)

(21) Appl. No.: 13/595,071

(22) Filed: Aug. 27, 2012

(51) Int. Cl. G06F 17/10

(52) U.S. Cl. 708/300

(57) ABSTRACT

A method of performing an infinite-impulse response digital filter includes switching address pointers between a first instance of the filter and a second instance of the filter; where the first and second instances represent the same filter. A first instance of the filter executes operations sequentially multiplying a current input data value, and first and second previous input data values, with corresponding ones of a first set of filter coefficients, using a multiplier; and a second instance of the filter executes operations sequentially multiplying first and second previous intermediate data values with corresponding ones of a second set of filter coefficients, using the multiplier. Switching between first and second instances of the filter occurs at each data input value or frame according to an alternating signal.

### BACKGROUND

1. Technical Field

This disclosure relates to the digital filtering of signals, and particularly to the optimization of digital filter computations in a processor.

2. Background

The digital filter is an important building block in the digital signal processing of audio information. As is well known in the art, digital filters can provide high precision processing of audio signals at very low cost, especially for audio applications in which the audio content emanates from a digital source to begin with. The capabilities of digital filters to precisely process audio signals has especially increased with the high performance digital signal processors (DSPs) that are now available. These advances have also resulted in custom and semi-custom logic circuits that have built-in digital filter blocks.

The infinite-impulse response (IIR) digital filter is an important type of digital filter for audio processing. The second order IIR digital filter, commonly referred to as a “biquad”, is a popular IIR building block, and can be cascaded to provide very high order digital filter functions at low cost and high efficiency.

Modern logic architectures have achieved some efficiencies in the execution of a biquad digital filter by identifying those operations that can be performed in parallel with one another. For example, a conventional biquad architecture can be implemented by way of a single multiply-and-accumulate stage (not illustrated). However, further optimizations are desirable.

The number of clock cycles required for execution of a biquad can become a critical parameter in the implementation of a digital signal processing function. In the audio processing context, the degree or extent to which digital filtering can be performed on an audio channel is limited by the amount of latency that can be tolerated in the system, and by the available clock rate. Conversely, if the desired level of filtering can be accomplished with fewer clock cycles, either the clock rate of the digital filters can be reduced, reducing the cost of the audio processor, or alternatively additional functionality may be implemented within the audio signal flow. In either case, a reduction in the number of clock cycles that are required to carry out digital filters directly translates into lower cost, or improved functionality, in an audio processing system.

### DRAWINGS

FIG. 1 is a conventional Direct-Form I representation of an IIR biquad filter.

FIG. 2 is a Direct-Form I representation of one-half of a complete process.

FIG. 3 is a Direct-Form I representation of the second half of a complete process.

### DESCRIPTION

The method disclosed here is adaptable to an integrated-circuit hardware optimization whereby a normally fixed algorithm to calculate a second-order IIR is modified in order to reduce the number of writes to storage elements that must be performed in order to compute the HR.

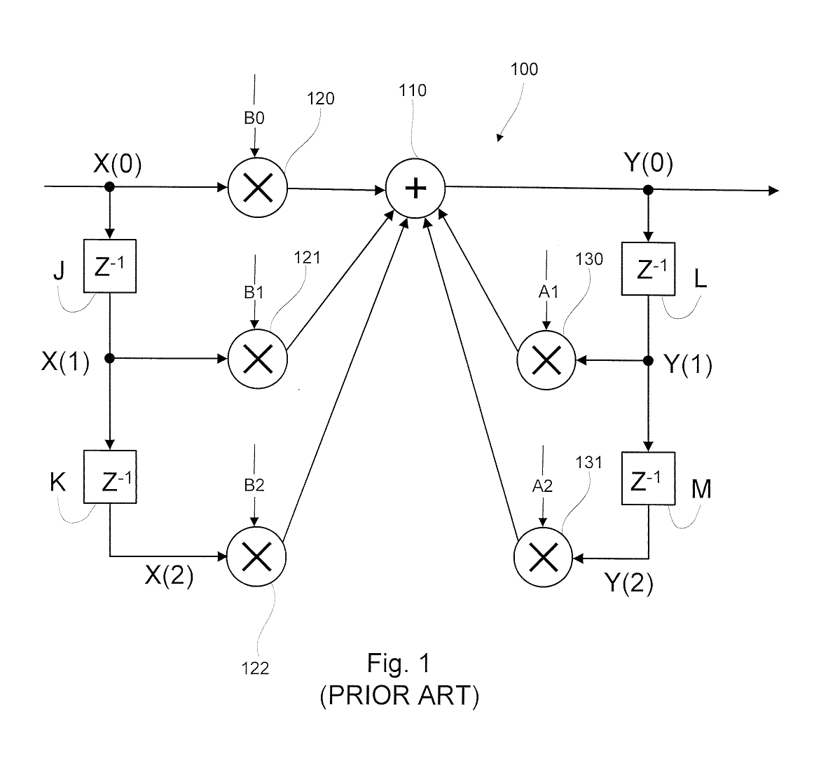

By way of background, FIG. 1 schematically illustrates the Direct Form I description of a conventional biquad filter (100). Input data stream X{n} is a sequence of discrete input values, which are processed by the filter (100) to produce output data stream Y{n}, also as a sequence of discrete values. The filter equation implemented by filter (100) of FIG. 1 can be expressed as:

Y(n)=B0·X(n)+B1·X(n−1)+B2·X(n−2)+A1·Y(n−1)+A2·Y(n−2)

where the sample indices n−1, n−2 refer to previous values of the input and output data streams. Referring to FIG. 1, the feed-forward side of digital filter (100) is implemented by a first multiplier (120) for multiplying current input value X(n) by coefficient BO, a second multiplier (121) for multiplying the next previous input value X(n−1) from delay stage J by coefficient B1, and a third multiplier (122) for multiplying twice-delayed input value X(n−2) from delay stage K by coefficient B2. On the feedback side, a fourth multiplier (130) multiplies the previous (once-delayed) output value Y(n−1) from delay stage L by coefficient A1, and a fifth multiplier (131) multiplies twice-delayed previous output value Y(n−2) from delay stage M by coefficient A2. The outputs of multipliers (120-122 and 130-131) are all applied to inputs of an adder (or accumulator) (110), and the resulting sum from the adder (110) constitutes the current output sample value Y(n). This direct-form representation is typical for second-order IIR digital filters, as is known in the art.

From this representation, one can readily derive the number of digital operations necessary for implementing a biquad digital filter. The necessary operations for conventional realizations (using registers for temporary storage):

| Operations | Number of instances |
|---|---|
| Clear accumulator | 1 |
| Data load | 5 |
| Coefficient load | 5 |
| Multiplications | 5 |
| Accumulate | 5 |
| Store | 4 |

These twenty-five operations can readily be seen from the Direct Form I illustration of FIG. 1. Each of multipliers (120-122, 130-131), require register loads of data values and coefficients; each delay stage J, K, L, M involves a store operation, and the adder (110) requires clearing of the previous result and accumulating of the current result.

There are many ways to compute an IIR using software, hardware, pencil and paper, etc. For integrated circuit designers, this is often done (for many reasons, taking into account residual error, saturation, number of required bits, available storage, MAC operations, etc.) using a Direct Form I architecture, as shown in the figures. With this arrangement, and for each IIR sample calculation, each storage element, labeled J, K, L, M, is both written and read. However, it is possible to cut in half the number of required writes if the inputs and outputs of adjacent storage elements can be alternated on the fly in a specific manner.

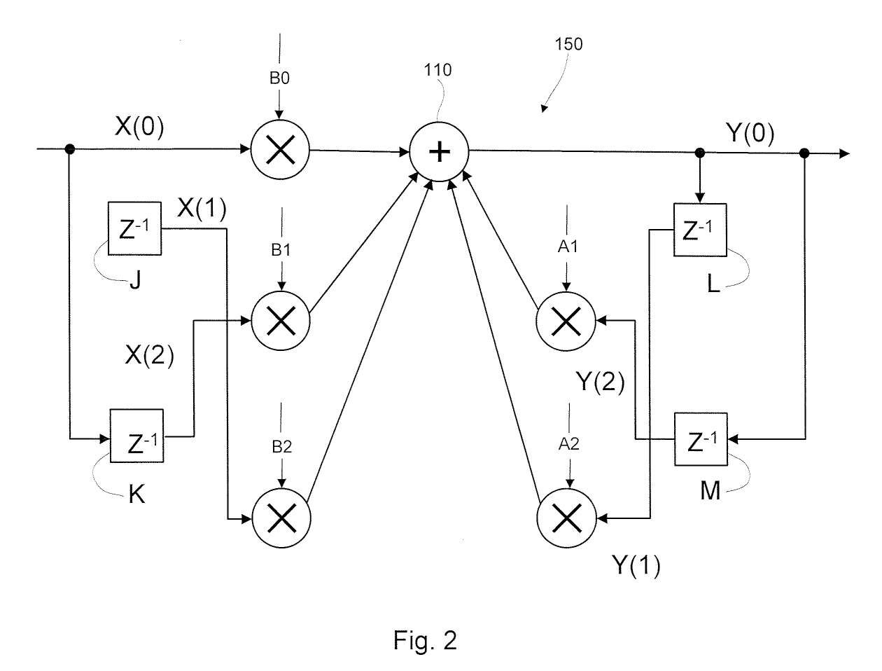

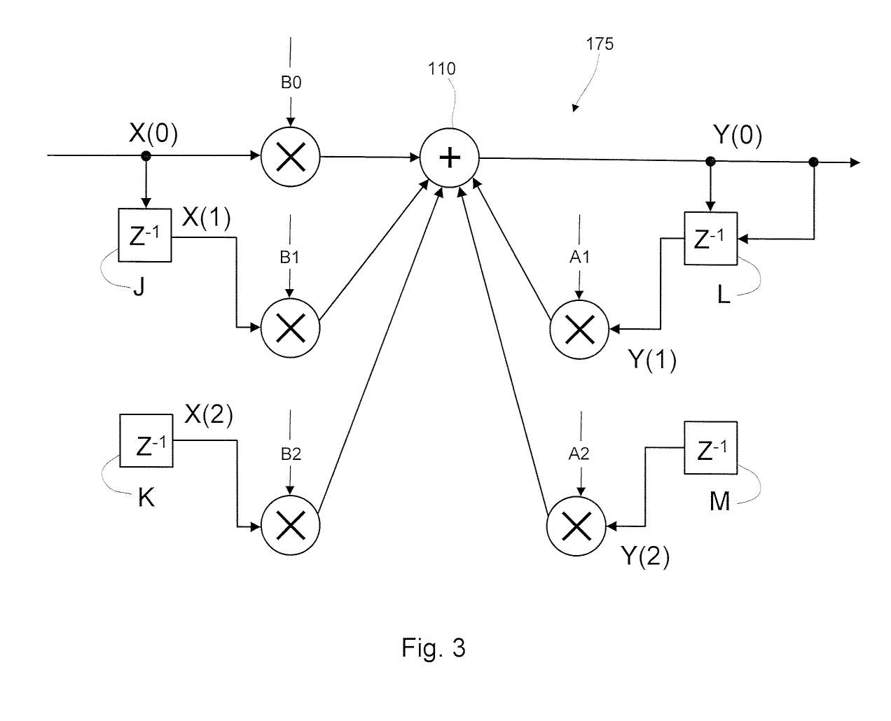

This can be accomplished by hardware that alternates states for every sample period, called here a “frame.” That is, the hardware switches between the states shown in FIGS. 2 and 3. Consider a signal called “EvenFrame,” such that for Frame 1, EvenFrame=0; for Frame 2, EvenFrame=1, for Frame 3, EvenFrame=0, etc. The processor hardware uses the EvenFrame signal to steer the read and write addressing operations. Steering means changing the data flow from that in FIG. 2 to that in FIG. 3 alternately.

The EvenFrame signal should be built into the instruction set such that there is no overhead to execute instructions. A processor having such a signal is the QF3DFX processor, manufactured by Quickfilter Technologies.

Assume that all data samples (J, K, L, and M) are in a single RAM. By convention, we allocate the FIG. 1 K value to be allocated at one address less than J, and M to be located at one address less than L (for all biquads), in a manner similar to below. The reader skilled in the art will recognize that other equivalent arrangements are possible.

The following table is an example of the manipulation of the address pointers:

| Address | Data |
|---|---|
| 10 | |
| 9 | |
| 8 | |
| 7 | |
| 6 | L |
| 5 | M |
| 4 | |
| 3 | J |
| 2 | K |
| 1 | |
| 0 | |

The code executing the filter reads the EvenFrame signal and, based on its value, either adds 1 to the RAM address pointer, or subtracts 1 from the address pointer. When EvenFrame is 0, the address pointer to the ram will access the RAM in the usual way. When EvenFrame is 1, at the point where there would normally be a reference to K, the logic adds 1 to the address pointer, meaning it will access J instead.

At the point where there would normally be a reference to J, the logic subtracts 1 from the address pointer, meaning it will access K instead. A similar sequence is used for L and M.

Assuming the address map from above, and that X(0) is in a variable called R0 already. The following pseudocode for each sample period shows the alternating pointer created by the EvenFrame signal and its application to the data in RAM:

```
If (EvenFrame = 0)
  offset=0;
Else
  offset=1;
addr = 2;
acc = acc + dataram(addr+offset)*b(2);
addr = addr + 1;
acc = acc + dataram(addr−offset)*b(1);
dataram(addr−offset)= R0;
addr = addr + 1;
acc = R0*b(0);
addr = addr + 1;
acc = acc + dataram(addr+offset)*a(2);
addr = addr + 1;
acc = acc + dataram(addr−offset)*a(1);
dataram(addr−offset)= acc;
EvenFrame = !EvenFrame;
```

The equivalent operation could be done in prior-art software but every software operation will require a checking of the state of the EvenFrame signal and then a determination of how to proceed to choose one addressing variant or the other of the biquad operation. Such an operation would consume more clock cycles than the embodiments disclosed and probably more clock cycles than the standard way of implementing the biquad calculation. Thus the number of writes can be cut in half, while the number of reads remains the same. There is no need for the data to be written into each register on every frame. Because the same data is accessed twice, once in frame N and once in frame N+1, it can just remain where it is and have the addressing change such that the data itself does not need to be written twice.

None of the description in this application should be read as implying that any particular element, step, or function is an essential element which must be included in the claim scope; the scope of patented subject matter is defined only by the allowed claims. Moreover, none of these claims are intended to invoke paragraph six of 35 U.S.C. Section 112 unless the exact words “means for” are used, followed by a gerund. The claims as filed are intended to be as comprehensive as possible, and no subject matter is intentionally relinquished, dedicated, or abandoned.

I claim:

1. A method of performing an infinite-impulse response digital filter, comprising:
in a first instance of the filter executing operations comprising:
sequentially multiplying a current input data value, and first and second previous input data values, with corresponding ones of a first set of filter coefficients, using a multiplier;
sequentially multiplying first and second previous intermediate data values with corresponding ones of a second set of filter coefficients, using the multiplier,
switching between the first instance of the filter and a second instance of the filter; where the first and second instances represent the same filter; then,
in the second instance of the filter executing operations comprising:
sequentially multiplying a current input data value, and first and second previous input data values, with corresponding ones of a first set of filter coefficients, in reversed order from the first instance, using a multiplier;
sequentially multiplying first and second previous intermediate data values with corresponding ones of a second set of filter coefficients, in reversed order from the first instance, using the multiplier; and,
wherein switching between the first and second instances of the filter occurs for each input data value.

2. The method of claim 1 further comprising:
generating a signal for each input data value, where the signal alternates between a first state and a second state; and,
wherein switching between the first and second instances of the filter occurs when the signal alternates between the first state and the second state.

3. The method of claim 1 where the switching between the first and second instance of the filter comprises switching between first and second address pointers.

4. The method of claim 3 where the first address pointer and the second address pointer point to data values.

5. An article of manufacture comprising a computer-readable medium having computer-executable instructions for performing an infinite-impulse response digital filter, the method comprising:
in a first instance of the filter executing operations comprising:
sequentially multiplying a current input data value, and first and second previous input data values, with corresponding ones of a first set of filter coefficients, using a multiplier;
sequentially multiplying first and second previous intermediate data values with corresponding ones of a second set of filter coefficients, using the multiplier,
switching between the first instance of the filter and a second instance of the filter; where the first and second instances represent the same filter; then,
in the second instance of the filter executing operations comprising:
sequentially multiplying a current input data value, and first and second previous input data values, with corresponding ones of a first set of filter coefficients, in reversed order from the first instance, using a multiplier;
sequentially multiplying first and second previous intermediate data values with corresponding ones of a second set of filter coefficients, in reversed order from the first instance, using the multiplier; and,
wherein switching between the first and second instances of the filter occurs for each input data value.

6. The article of manufacture of claim 5 where the method further comprises:
generating a signal for each input data value, where the signal alternates between a first state and a second state; and,
wherein switching between the first and second instances of the filter occurs when the signal alternates between the first state and the second state.

7. The article of manufacture of claim 5 where the switching between the first and second instance of the filter comprises switching between first and second address pointers.

8. The article of manufacture of claim 7 where the first address pointer and the second address pointer point to data values.
